(19) United States
(12) Patent Application Publication
(10) Pub. No.: US 2014/0026370 A1
(43) Pub. Date: Jan. 30, 2014

(54) Garden Rake Handle

(71) Applicant: Jerry Stuart Pearl, Moon Township, PA (US)

(72) Inventor: Jerry Stuart Pearl, Moon Township, PA (US)

(21) Appl. No.: 13/560,017

(22) Filed: Jul. 27, 2012

(51) Int. Cl. B25G 1/10

(52) U.S. Cl. 16/430

(57) ABSTRACT

A rake handle curved forward with one hand in front of the other grasping onto hand grips allowing for ergonomic head and neck, and upper and lower extremity positioning, comfort and alignment. It is bolted to a rake tine head positioning the user behind the tines.

The rake handle is curved to maximize body alignment and reduce fatigue.

The rake handle can be made of metal or plastic tubing, and bent to the desired specifications.

The ergonomics of placing one hand in front of the other in a midline position to the body and chest, along with feet, and hips parallel to one another, reduces fatigue and body strain, since the counter-rotation of the shoulder girdle rotating opposite to the hips and pelvis, as experienced with conventional raking, is significantly reduced, and can be eliminated, while maintaining optimal control of the rake.

### SUMMARY

A curved handle rake, with hand grips for upper extremity positioning connected to a rake tine head. The rake handle and connected tine head positions the user behind the rake. The handle, or shaft, has a forward curve toward the top of the handle, or shaft. The bottom end of the shaft is attached to the tine head.
1. The shaft has a bottom portion that attaches into the tine head.
2. The shaft has a middle section.
3. The shaft has an upper portion, or neck, which begins to extend into the top end, or head end of the curve.
4. The handle has a top end, or head portion, which forms a curve, which extends away from the shaft. The handle has an end point to the top end of the curve.134

On the top end of the shaft, before the handle curves forward, or away from the user, one hand grip is fitted upon the shaft of the handle. On the handle's final curve, it bends the furthest from the user. As the curve bends toward the end point of the shaft handle, a second grip is secured. The two grips allow for maximum control of the rake. Along the embodiment, the hand grips are secured to their determined positions, although the user is able to adjust them for maximum comfort and control.

The first gripping position is forward to the second gripping position. This places the upper extremities in a forward and midline position to the user's body, or trunk/chest. The two gripping positions allow for both shoulders to remain parallel, and wrists in a neutral position. The wrist position is perpendicular to the ground and measures zero degrees of wrist supination, arms positioned in nearly the same plane of motion; trunk and head in alignment; hips and lower extremities parallel. Supination is a measured motion of the wrist beginning with zero degrees, or neutral, with thumb, wrist and palm 90 degrees to the ground.

Because of the above mentioned body stance, fatigue and body strain are reduced, since the counter-rotation of the shoulder girdle rotating opposite to the hips and pelvis, as experienced with conventional raking, is significantly reduced, and can be eliminated.

### DESCRIPTION OF THE PREFERRED EMBODIMENT

Before explaining the present invention in detail, it is to be understood that the garden tool handle as shown with an attached rake tine head with flexible metal tines, is not limited to only such a rake head as illustrated in the accompanied drawings, since the garden tool handle is capable of being attached to other tool head implements, such a garden hoe.

For the purposes of description only, the said terminology and phrasing had been used and should not be considered limited to, or exclusive to said description.

The drawings indicate the embodiment of the invention with an attached metal rake tine head with flexible tines, but should not be considered exclusive to the design.

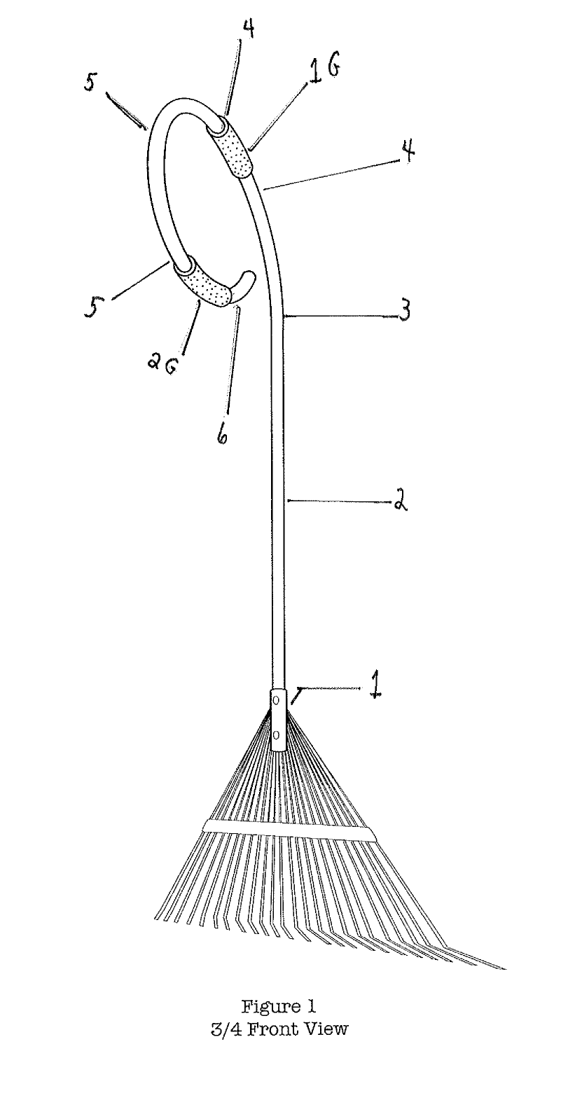

FIGS. 1,2, 3,4 5, and 6 show the garden tool handle with a rake tine head attached (1). The bottom, or the end of shaft is attached to the rake tine head by nuts, bolts, rivets, glue, friction, or any other suitable fastening combination, or system. In the embodiment, the handle and rake tine head are a single component piece. The shaft, or mid-section of the handle (2) exhibits the longest straight section. The handle begins to curve into the top section of the shaft (3) and continues through and above the first gripper (1G) to the head portion, or top, curve of the handle (5). The curve continues forming the end portion, or final, curve of the handle (6), as it passes through the second grip (2G). The head, or top, curve of the handle is the uppermost aspect of the garden tool handle. The handle begins to curve forward with section (4) then forming the most significant angle with section (5), and finally, forming the end curve with section (6), which includes the second grip (2G).

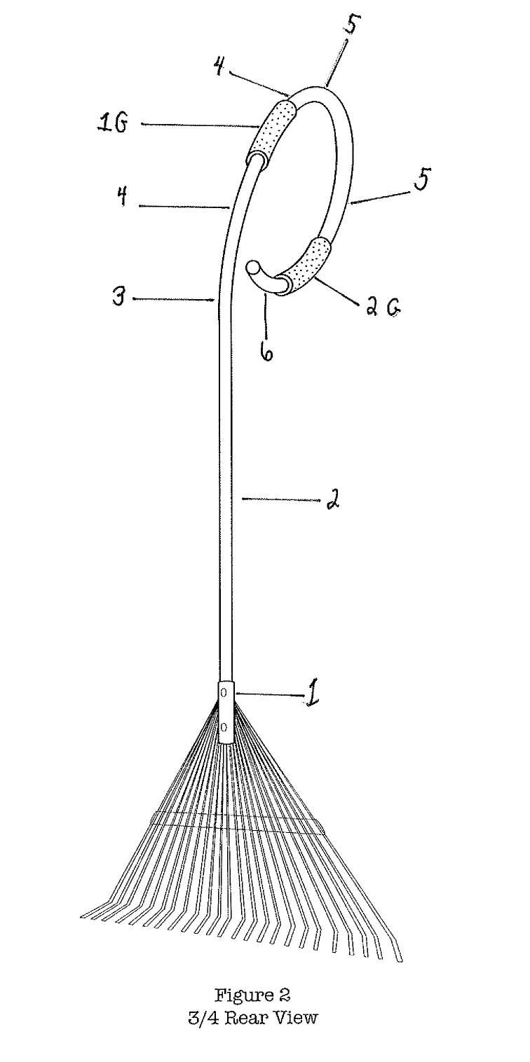

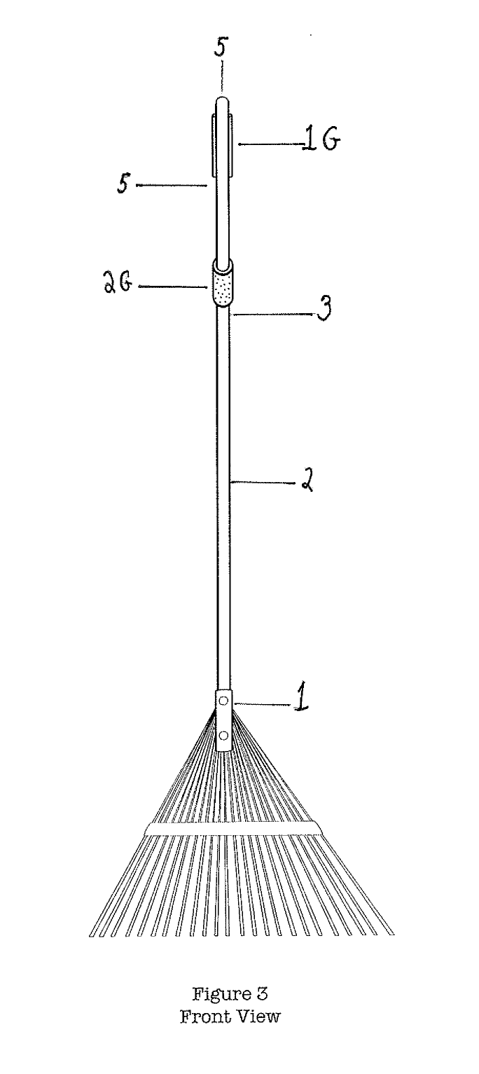

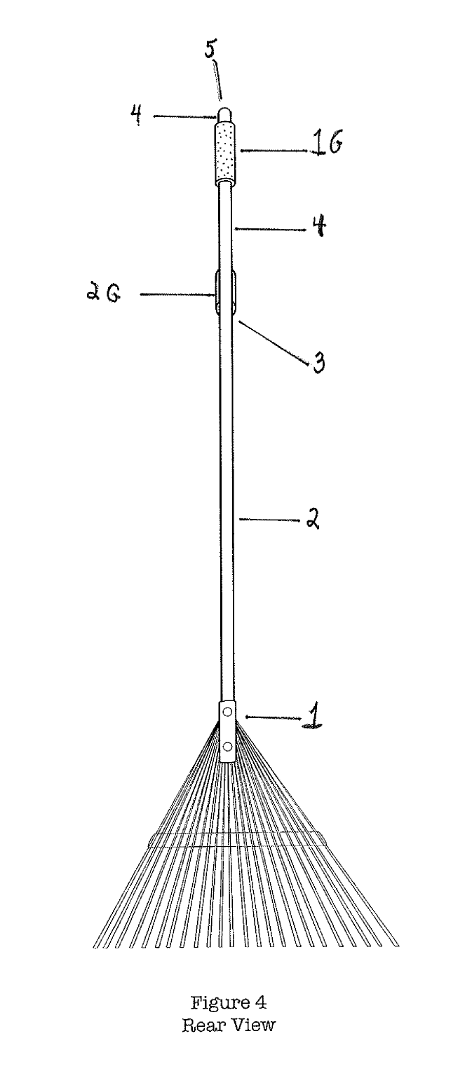

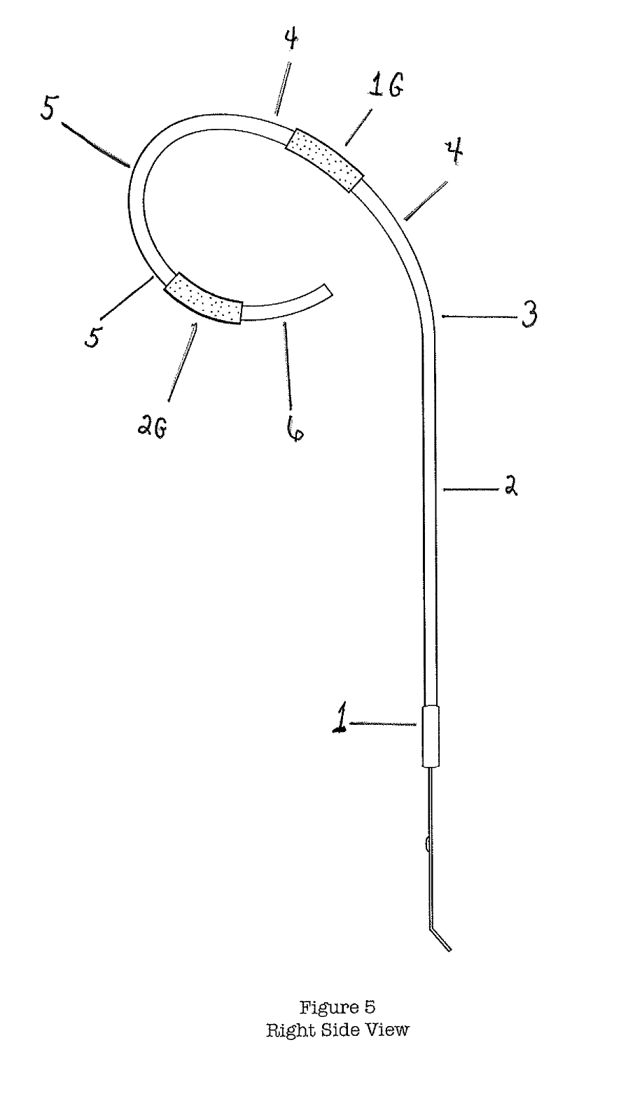

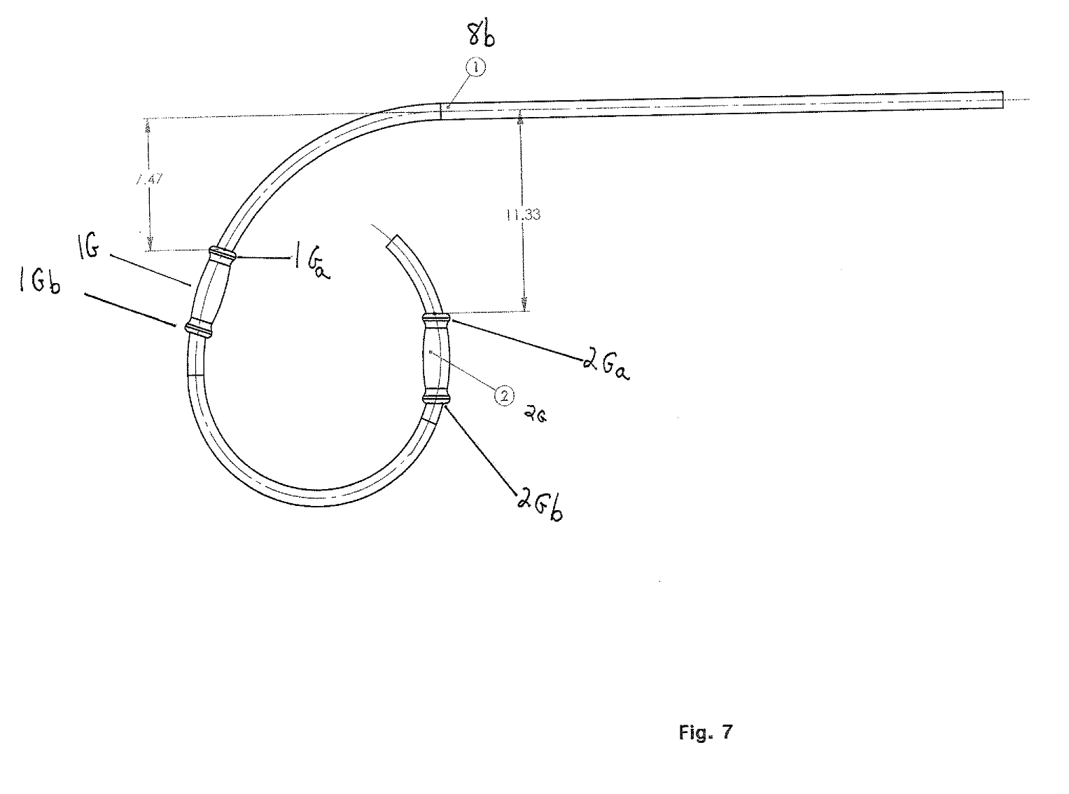

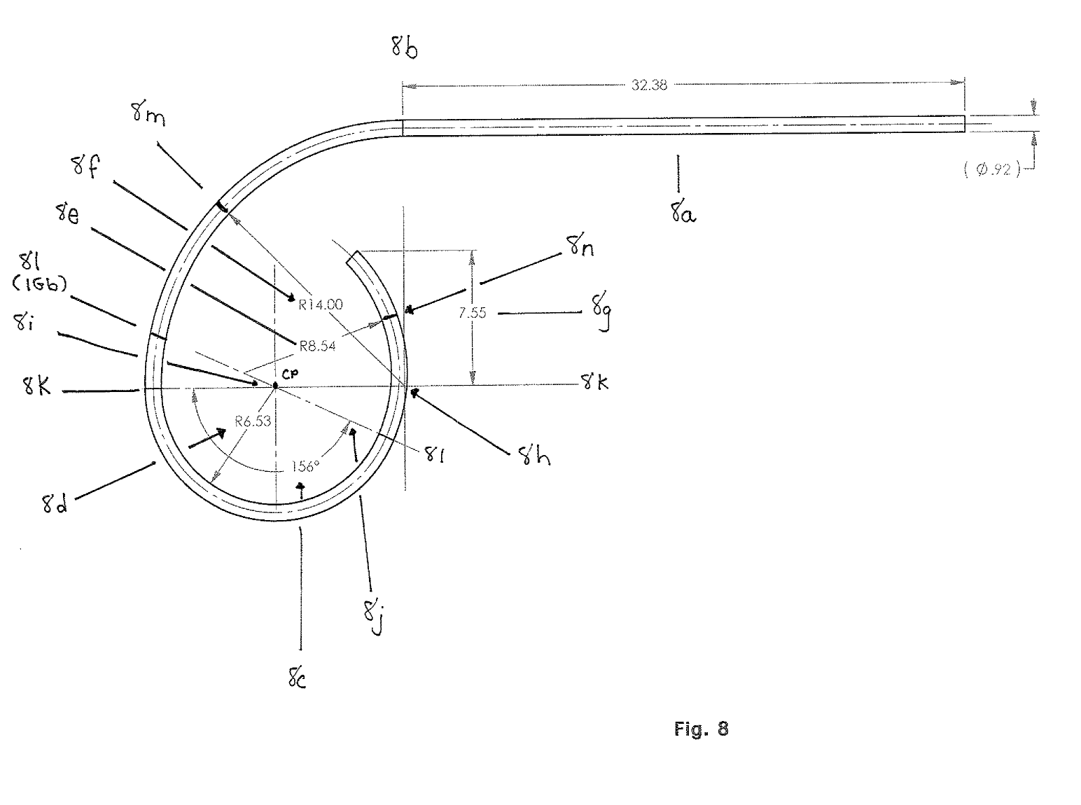

FIGS. 7 and 8 demonstrate an additional variation toward the measurements of the garden tool handle that have been shown in FIGS. 1-5. FIG. 7 defined the placement of the two grippers, but should be noted the placement is not exclusive to the design. Handles could be adjusted for personal comfort, although the inclusion of the two handles is a defining feature of the use of the handle as a garden tool. The placement of the two handles in FIG. 7 had been placed in the embodiment in such a way as to achieve initial ergonomic posture and form, as well as comfort for use. The placement of (1G) is 7.47 inches and the distance between the shaft, or midsection of the handle, and (1Ga). (2G) is 11.33 inches between the shaft or midsection of the handle and (2Gb). The diameter of the tube in the embodiment measures 0.92 inches, but is not exclusive to the design. FIG. 8 measures the garden tool handle from the bottom, measuring 32.38 inches to where the forward curve of handle lines with the point on the handle referred to as (8h). The measurement of 7.55 inches (8g) is the distance between the end point of the handle, as measured from the center point (CP) to the handle's end point using a 90-degree angle, that follows the top end of the handle at (8h) to (8b) on the shaft. (8h) identifies the placement, on the embodiment, for the user's hand to rest comfortably upon the pad of the second gripper (2G). The gripper (2G) is in alignment with the center point (CP) as indicated with point (8h), or the vertex of the angle. The measurement R14.00 inches between point (8h), the vertex, and with (8b), one arm of the angle, as it forms a 90-degree angle with the point on the shaft where the handle begins the curving of the neck section of the handle. R14.00 inches is the point where the vertex (8h) and, the one arm of the angle, (8k) and, the second arm, (8m) are 45-degrees apart from each other. This is the point where the arc of the top section, or head, begins to embody the intentional ergonomic design of the handle, and the neck of the handle ends. The measurement R8.54 inches has a relevant relationship with the center point (CP). R8.54 inches is the placement location on the lower section of the top end that embodies the second gripper (2Gb) as indicated in FIG. 7. The flexibility of the second gripper (2G) could be adjusted so the edge (2Ga) could be placed on that point for an alternative ergonomic position. R6.53 is the distance from (8i), the center point (CP) of the handle's arc as it embodies the top end, or head, of the handle, while forming the 180-degree arc of the top section of the handle required for placement of the two grippers. The 156-degree arc is formed between point (8j) as indicated by the line passing through the center point (CP) and point (8l), which is the location of the first gripper (1G), specifically (1Gb) as indicated in FIG. 7.

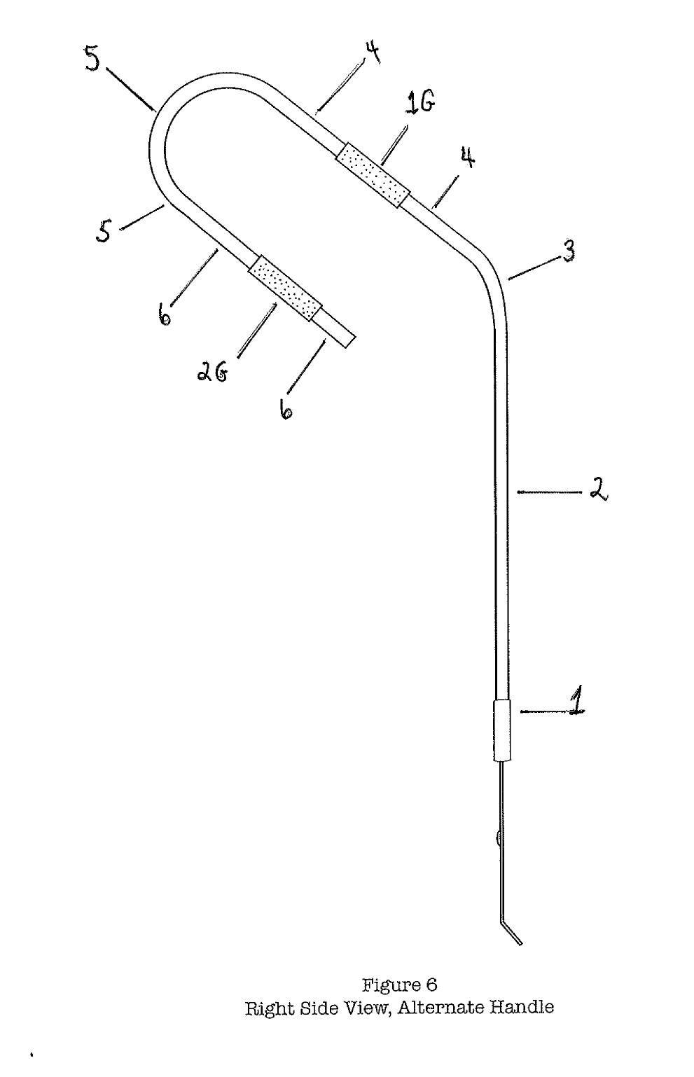

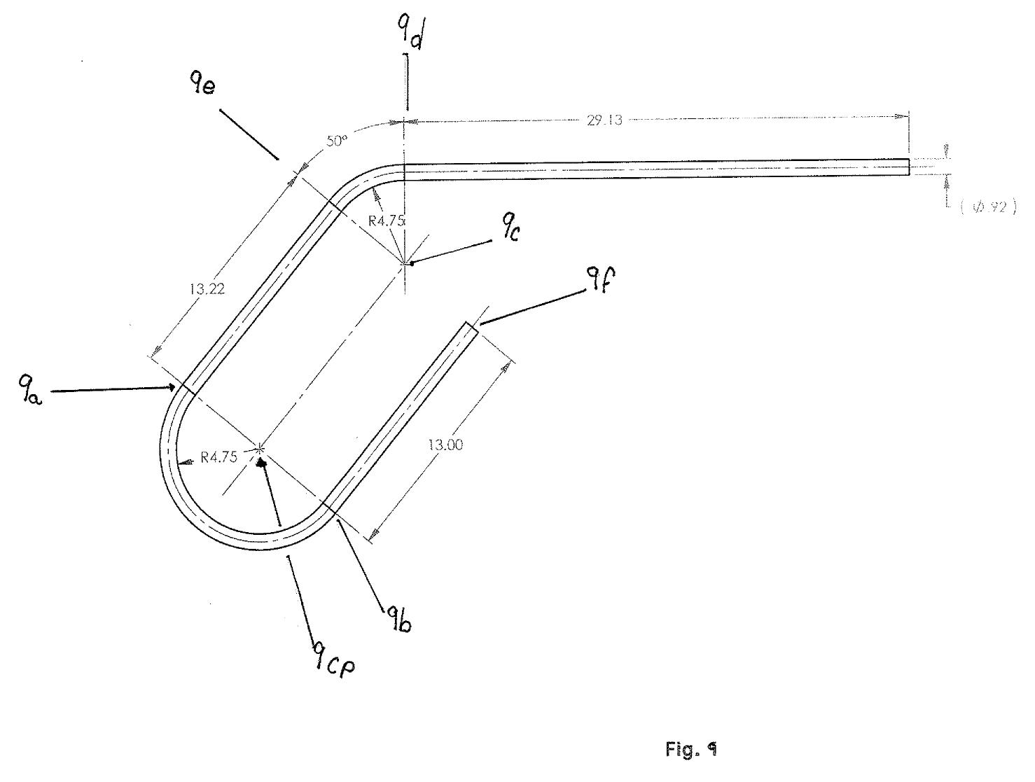

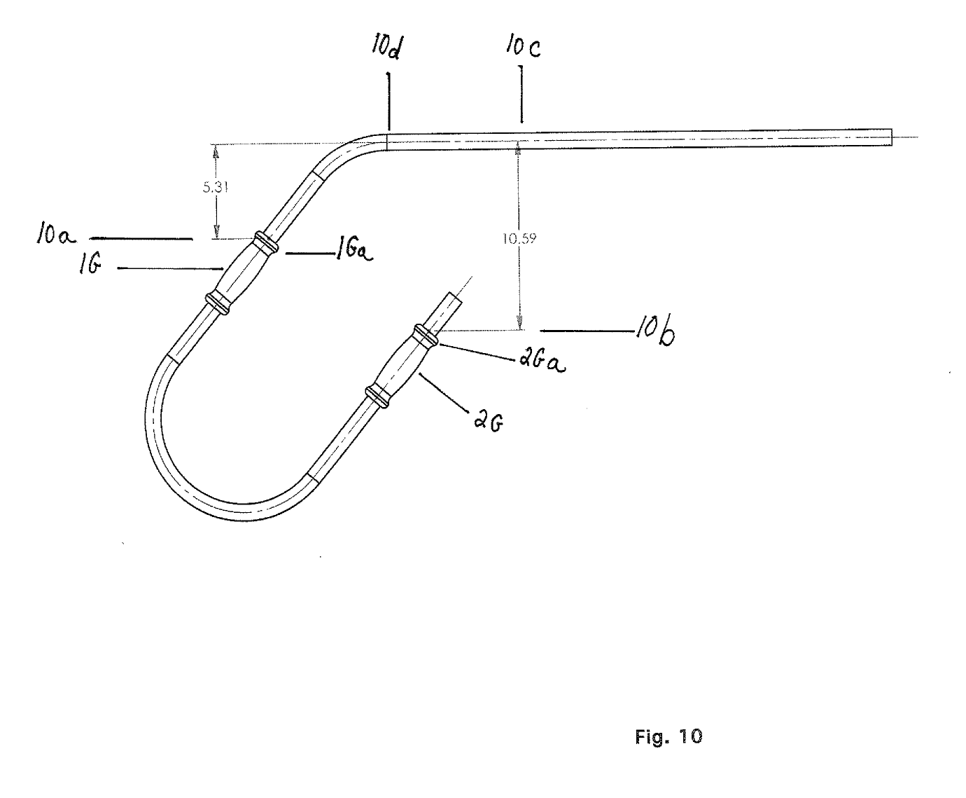

FIGS. 9 and 10 demonstrate an additional variation toward the measurements of the “Alternate” garden tool handle that is the embodiment drawing labeled FIG. 6. FIG. 9 measures the handle from the bottom end of the shaft to the first curve, which is 29.13 inches with the tube diameter measuring 0.92 inches, but is not exclusive to the design. The first curve begins at point (9d). The first curve forming the neck of the handle begins at point (9d) and ends at point (9e) forming an arc of 50-degrees. The measurement of R4.75 inches is determined by creating point (9c), the vertex of the 50-degree angle, and (9CP), the center point between the beginning of the top curve section (9a), and the end of the top curve section of the handle (9b). (9C)) is the center point of the top curve of the handle, and the center point between (9e) and (9f). The measurement of 13.22 inches is the straight section of the handle between the first curve of the neck of the handle, and the beginning curve forming the top curve, or head section, of the handle, which is between points (9a) and (9b). The measurement of 13.00 inches is the straight section of the handle between the end of the top curve, or head section, of the handle, which is between points (9b) and (9f).

FIG. 10 defined the placement of the two handles, but should be noted the placement is not exclusive to the design. Handles could be adjusted for personal comfort, although the inclusion of the two handles is a defining ergonomic feature of the use of the handle as a garden tool. The placement of the two handles in FIG. 10 had been placed in the embodiment in such a way as to achieve optimal ergonomic form and comfort for use. The placement of (1G) measures 5.31 inches between the distance between the end of the straight shaft, or midsection of the handle (10d), and (1PG). The measurement of 5.31 inches is determined by calculating the distance from point (10d), which is the same as (9d) in FIG. 9, (This is the point where the shaft begins to form the first curve, which embodies the neck of the handle.) and the first gripper at point (1Ga). 10.59 inches is determined by measuring the related point on the second gripper (2G), which is (2Ga), and the shaft of the handle.

1. Adjustable, moveable cylindrical grippers allow for user to achieve the most functional and comfortable position.

2. The garden tool handle is designed to allow the user's forearms and wrists to be positioned in neutral or as close to a neutral position.

3. The garden tool handle, as described in claim 1, places the hands in two distinct positions. The first grip, which is closest to the body, allows the hand to hold the gripper vertically. The second grip, which is furthest from the body, allows the hand to hold the gripper, also, vertically. Both hands and forearms are positioned ergonomically in a comfortable, neutral position.

4. The garden tool handle places the user's body in an ergonomic posture with the handle, which is in-line with the user's chest, or trunk. The handle remains in-line with the user's trunk throughout the task. The head and neck are in alignment to the user's body throughout the raking motion. The shoulders, hips, knees, and feet remain in alignment and perpendicular to the handle and rake head.

5. The garden tool handle has a top, or head curvature, which is the highest portion of the handle's shaft. The handle originates at the rake tine attachment, or foot, and forms the longest portion of the handle. At the uppermost portion of the handle's shaft, it begins to curve forming the head, or top portion of the handle. Where it begins to form the top, that portion will be referred to as the neck of the handle, or shaft. A gripper is fitted on this section, as described in claim 1. The top, or head, curves forward and downward to the handle's end where the second gripper is fitted, as described in claim 1, allowing both hands to remain in the same plane of motion.

6. The garden tool handle, as described in claim 5, allows the user to position both hands in-line to each other, and to the user's chest, or trunk. This alignment: user's trunk/chest-to-hand 1-to hand 2 provides for optimal ergonomics during the task.

7. The garden tool handle, as described in claim 5, places the user in an ergonomic posture and stance (as it keeps the rake head in a position, whereby the) allowing for the rake tines (are at an angle that allow them) to efficiently move the material on the ground once the user grasps the garden tool handle's grippers with both hands. The bottom of the shaft, or the foot, of the handle is securely fastened to the tool implement, such as a rake head as seen in the drawings. The combination of angles and straight sections forming the shaft of the handle, which includes the neck of the shaft, and then the curved top section, and then, forming the forward curve to the end of the handle is designed specifically to create an ergonomic posture, as well as task efficiency, for the user.

8. The garden tool handle when attached to the rake tines allows for a unique ergonomic motion when applied to the action of, for example, raking. As defined in all the above claims, the body, shoulders, hips, legs, and feet are positioned in a symmetrical position and in-line with the garden tool handle shaft during the action of raking, which is to draw the rake tines toward the user, as the user grasps the two hand grips.
